(19) United States
(12) Patent Application Publication
(10) Pub. No.: US 2023/0057104 A1
(43) Pub. Date: Feb. 23, 2023

(54) PROTECTIVE COVER FOR CEILING AND WALL MOUNTED FIXTURES

(71) Applicant: Robert A. Hidalgo, Miami, FL (US)

(72) Inventor: Robert A. Hidalgo, Miami, FL (US)

(21) Appl. No.: 17/892,462

(22) Filed: Aug. 22, 2022

Related U.S. Application Data
(60) Provisional application No. 63/235,446, filed on Aug. 20, 2021.

(51) Int. Cl. B05C 21/00

(52) U.S. Cl. CPC B05C 21/005

(57) ABSTRACT

A protective cover for covering a ceiling or wall mounted fixture includes an open mouth surrounded by a rim and a flexible body extending from the open mouth and surrounding an interior chamber. The interior chamber is sized and configured to accommodate the entire fixture therein. A drawstring extends about the top rim and is pulled at least at one location to close the open mouth against the mounting portion of the fixture adjacent the ceiling surface, thereby protectively encapsulating the entire fixture within the interior chamber of the cover. An adhesive material may be provided about an inner side of the top rim to help hold the top rim against the mounting portion of the fixture.

### BACKGROUND OF THE INVENTION

This non-provisional patent application is based on provisional patent application Ser. No. 63/235,446 filed on Aug. 20, 2021.

### FIELD OF THE INVENTION

The present invention relates to a cover device for covering ceiling and wall mounted fixtures and, more particularly, to a flexible member having an interior chamber and an open mouth that is closed by a drawstring or other mechanism to encapsulate the entire fixture therein.

### DESCRIPTION OF THE RELATED ART

The task of painting the surfaces of a house or building structure involves initial preparation work to protect furniture, floor surfaces, various electrical fixtures, baseboard, trim and decorative molding from contact with paint applied by a brush, a roller or a sprayer. Also, paint may drip as it is applied, so it is important to cover all items and surfaces that could get paint on them during the painting process. When painting a ceiling that has one or more fixtures and/or structures mounted to the ceiling or an adjacent wall, it can be a time consuming and rather awkward procedure to protectively cover these fixtures and structures so that they do not get any paint on them. To cover a ceiling fan, for example, each of the blades of the fan need to be covered individually with plastic, cloth or paper and then the motor and mounting flange, as well as other parts, such as a light fixture, need to be covered using paper and tape. Some homes include multiple ceiling fans, thereby requiring a significant amount of preparation time just to protect the ceiling fans. This, in addition to covering and protecting other fixtures, structures and surfaces can often involve as much time as the actual job of painting.

In order to make the task of protecting ceiling and wall mounted fixtures and structures such as ceiling fans, chandeliers, pendant lighting, wall light sconces, artwork (e.g., sculptures), etc. when painting a ceiling, there remains a need for an improved cover device that is easily and efficiently installed to entirely cover and protect each fixture and structure from paint that might be sprayed, rolled or brushed on a ceiling surface above the fixture or structure.

### SUMMARY OF THE INVENTION

The present invention is directed to a protective cover device for covering ceiling and wall mounted fixtures and structures. The protective cover device includes an open mouth surrounded by a rim and a flexible body extending from the open mouth and surrounding an interior chamber that is sized and configured to accommodate passage of a chandelier, the blades and motor of a ceiling fan or other cumbersome fixture therein. In a further embodiment, the interior chamber is sized and configured to also accommodate a light fixture that is attached to the ceiling fan, typically below the blades. A drawstring extends about the top rim of the cover device and is pulled to close the open mouth tightly against the very top mounting hardware of the fixture that fits against the ceiling surface. In this manner, the entire fixture or structure, including the hanging and mounting portions are all protectively covered within the one protective cover device that can be easily and quickly installed. An adhesive material may be provided at or near the top rim to help hold the top rim of the cover device against the mounting hardware of the fixture with the drawstring pulled to tightly close the open mouth of the cover device against the mounting hardware.

### BRIEF DESCRIPTION OF THE DRAWINGS

For a fuller understanding of the nature of the present invention, reference should be had to the following detailed description taken in connection with the accompanying drawings in which:

FIG. 1 is a front, top perspective view of the cover device of the present invention;

FIG. 2 is a side elevational view, in partial cross-section, showing the cover device installed to fully cover a ceiling fan mounted to a ceiling; and

FIG. 3 is a side elevational view, in partial cross-section, showing the cover device installed to fully and protectively cover a ceiling fan and a light fixture on the ceiling fan.

Like reference numerals refer to like parts throughout the several views of the drawings.

### DETAILED DESCRIPTION OF THE PREFERRED EMBODIMENTS

Referring to the several views of the drawings, the protective cover device of the present invention is shown and is generally indicated as 10. The cover device 10 includes a main body 12 and an open mouth 14 surrounded by a top rim 16. The open mouth 14 communicates with an interior chamber 18 that is specifically sized and configured to surround a fixture 100 or other structure (e.g., a sculpture) that is mounted to a ceiling 110. Examples of fixtures and structures that can be protectively covered by the cover device 10 include, but are not limited to: chandeliers; pendant lights; wall light sconces; ceiling fans; and artwork.

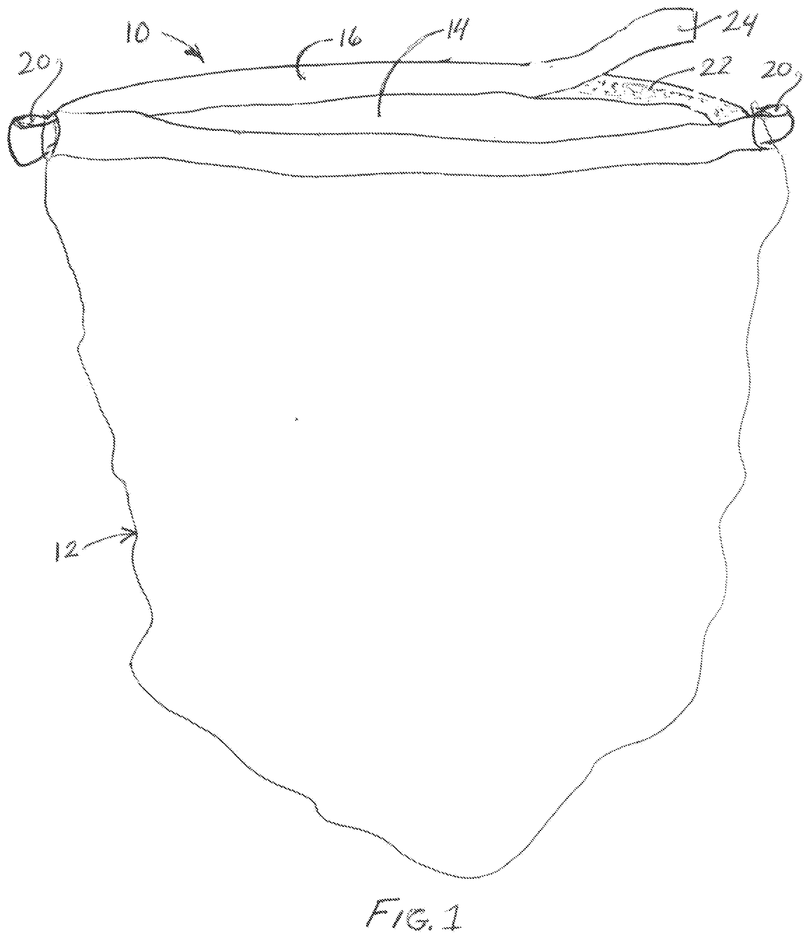

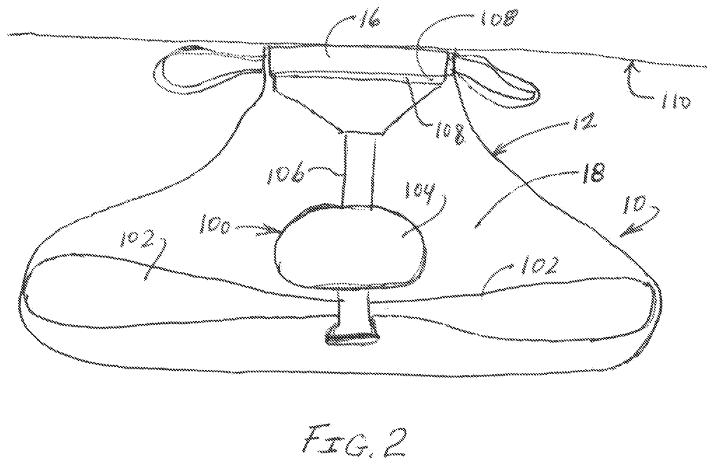

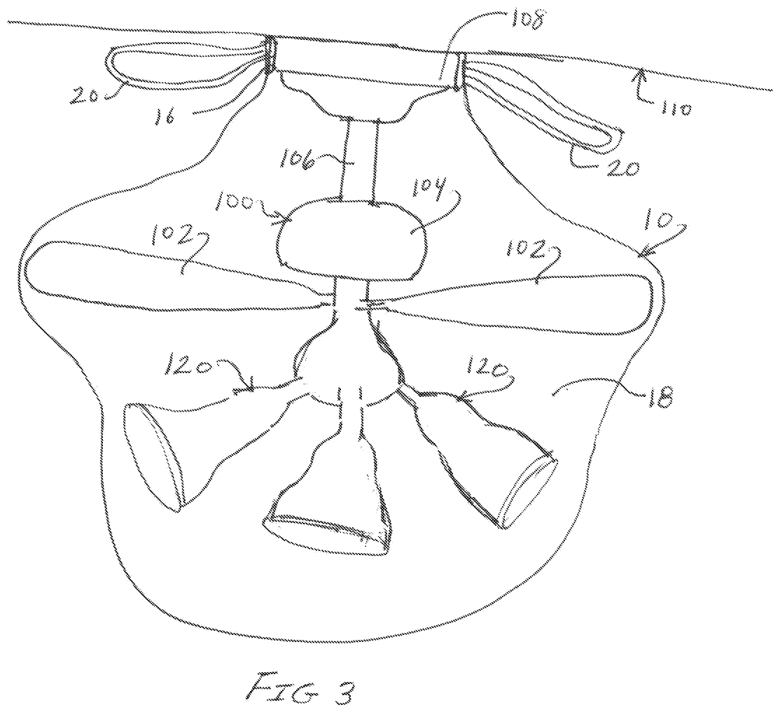

In one particular example shown in FIGS. 2 and 3, the fixture 100 is a ceiling fan and the open top mouth 14 is sized to allow easy passage of the several fan blades 102 of the ceiling fan therethrough when the mouth is fully open. Once the entire ceiling fan is within the confines of the interior chamber 18 of the cover device 10, a closure mechanism is operated to contract the open mouth. In the examples shown in FIGS. 2 and 3, the closure mechanism is a drawstring 20 that is pulled to tighten the top rim of the cover device 16 against a mounting hardware 108 of the ceiling fan fixture 100. Other closure mechanisms are fully contemplated within the spirit and scope of the invention. For example, the top rim may be provided with releasable securing tabs similar to those found on a baby diaper. The top rim is also provided with a releasable attachment mechanism for releasably attaching the top rim to the mounting hardware 108. In the example shown in FIG. 1, the releasable attachment mechanism is an adhesive substance 22 on an inner facing surface of the top rim that is initially protected by a peel away film 24. During installation, the film 24 can be removed to expose the adhesive 22. Upon tightening the top rim 16 against the mounting hardware 108 of the fixture 100, the adhesive substance 22 eventually engages the sides of the mounting hardware 108 to help secure the cover device in place on the mounting hardware 108 adjacent to the ceiling surface. It should be noted that the adhesive is a releasable type of adhesive that will not permanently stick to the mounting hardware and will not damage the finish of the particular mounting hardware. In the two examples shown in FIGS. 2 and 3, the interior chamber is specifically sized to surround the fan blades 102, the motor 104, the elongate vertical stem 106 and the mounting hardware 108 of the ceiling fan fixture 100. In this example, the fan blades 102 and the motor 104 define a primary structure of the fixture 100. In the example shown in FIG. 3, the interior chamber 18 is sized and configured to also surround a light fixture 120 that may be attached to the ceiling fan fixture 100, typically below the fan blades 102. In this example, the fan blades 102, the motor 104 and the light fixture define a primary structure of the fixture 100. In both of the examples of FIGS. 2 and 3, a distance measured about the outer tips (i.e., ends) of the fan blades 102 defines an outer periphery of the primary structure of the fixture 100. It is important to note that the outer periphery of the primary structure is significantly greater than an outer periphery of the mounting hardware 108. In at least one embodiment of the invention, the outer periphery of the primary structure is at least three times greater than the outer periphery of the mounting hardware 108. In the fully open position, the open mouth is larger than the outer periphery of the primary structure.

The protective cover device 10 of the present invention may be made of a lightweight disposable plastic material or, alternatively, of a more durable flexible material that is suitable for extensive use, such as protecting outdoor ceiling fans from dirt and dust when not in use.

While the present invention has been shown and described in accordance with several preferred and practical embodiments, it is recognized that departures from the instant disclosure are fully contemplated within the spirit and scope of the present invention which is not to be limited.

What is claimed is:

1. A protective cover and fixture assembly comprising:
a fixture including a mounting portion and a primary structure, and the mounting portion being structured and disposed for mounting the fixture to a ceiling or wall, and the mounting portion having a first outer periphery, and the primary structure having a second outer periphery, and the second outer periphery of the primary structure being significantly greater than the first outer periphery of the mounting portion;
a cover device including a main body and an open mouth surrounded by a top rim, and the main body surrounding an interior chamber that is sized and configured to surround the primary structure and the mounting portion of the fixture, and the open mouth communicating with the interior chamber and being operable between a fully open position and a contracted position, and the open mouth being sized and configured to allow passage of the outer periphery of the primary structure therethrough and into the interior chamber when the open mouth is in the fully open position;
a closure mechanism on the top rim for operating the open mouth between the fully open position and the contracted position; and
a releasable attachment mechanism on the top rim for releasably attaching the top rim to the mounting portion of the fixture.

2. The protective cover and fixture assembly as recited in claim 1 wherein the releasable attachment mechanism includes an adhesive substance on an inner facing surface of the top rim for releasably attaching the top rim to the outer periphery of the mounting hardware.

3. The protective cover and fixture assembly as recited in claim 2 further comprising:
a protective peel away film covering the adhesive substance, and the protective peel away film being structured and disposed to be removed to fully expose the adhesive substance on the inner facing surface of the top rim prior to operating the closure mechanism to move the open mouth to the contracted position, thereby causing the adhesive substance to engage and releasably attach to the outer periphery of the mounting hardware.

4. The protective cover and fixture assembly as recited in claim 1 wherein the closure mechanism is a drawstring extending about the top rim and being operable to close the open mouth from the fully open position to the contracted position against the mounting hardware.

5. The protective cover and fixture assembly as recited in claim 1 wherein the second outer periphery of the primary structure is at least three times greater than the first outer periphery of the mounting portion.
